(19) United States
(12) Patent Application Publication
(10) Pub. No.: US 2023/0211777 A1
(43) Pub. Date: Jul. 6, 2023

(54) ASSISTANCE SYSTEM WITH LEADER DETERMINATION MODULE FOR AUTOMATED VEHICLE IN A MERGING TRAJECTORY

(71) Applicant: GM GLOBAL TECHNOLOGY OPERATIONS LLC, Detroit, MI (US)

(72) Inventors: Sharon Hornstein, Pardes Hanna (IL); Daniel Urieli, Herzliya (IL)

(73) Assignee: GM GLOBAL TECHNOLOGY OPERATIONS LLC, Detroit, MI (US)

(21) Appl. No.: 17/569,042

(22) Filed: Jan. 5, 2022

(51) Int. Cl. B60W 30/09

(52) U.S. Cl. CPC B60W 30/09; B60W 2420/42; B60W 2520/10; B60W 2420/52; B60W 2520/12; B60W 2554/4042; B60W 2554/4041; B60W 2554/802; B60W 2554/4045; B60W 2554/801; B60W 2552/10; B60W 2520/06; B60W 2556/60; B60W 2420/54; B60W 2552/05; B60W 2555/60

(57) ABSTRACT

An assistance system for a vehicle capable of automated operation has a controller having a processor and tangible, non-transitory memory on which instructions are recorded. The vehicle is located on a first lane in a vicinity of one or more neighboring vehicles, the first lane merging with a second lane at a merging trajectory location. The controller is adapted to selectively execute a leader determination module when a distance of the vehicle to the merge starting point is less than a threshold value. This includes determining an estimated arrival time of the vehicle to a merge starting point of the merging trajectory location. The controller is adapted to select a leader vehicle from the neighboring vehicles based in part on their respective estimated arrival times to the merge starting point. Operation of the vehicle is controlled based in part on the leader vehicle.

### INTRODUCTION

The present disclosure relates generally to an assistance system for an automated vehicle. More specifically, the disclosure relates to a leader determination module for an automated vehicle approaching a merging trajectory location. Advanced driver assistance systems and autonomous vehicles generally incorporate various systems for efficient operation, such as blind spot information systems, lane departure warning systems and adaptive cruise control systems. Some of these systems may rely on determination of a “leader vehicle” to guide the operation of the vehicle. However, determining the leader vehicle is a non-trivial and challenging process, particularly in cases of unstructured heavy traffic and merging driving trajectories, such as in on-ramps and lane-merges.

### SUMMARY

Disclosed herein is an assistance system for a vehicle capable of automated operation. The system has a controller having a processor and tangible, non-transitory memory on which instructions are recorded. The vehicle is located on a first lane approaching a merging trajectory location and is in the vicinity of one or more neighboring vehicles. The merging trajectory location defines a merge starting point. The controller is adapted to selectively execute a leader determination module for selecting a leader vehicle when a distance of the vehicle to the merge starting point is less than a threshold value. Operation of the vehicle is controlled based in part on the selection of the leader vehicle.

Execution of the module includes determining an estimated arrival time of the vehicle to reach the merge starting point. The controller is also adapted to determine respective estimated arrival times for the neighboring vehicles to the merge starting point. The leader vehicle is selected from the neighboring vehicles based in part on the respective estimated arrival times.

In some embodiments, the first lane merges with a second lane at the merging trajectory location. The neighboring vehicle that has the greatest value of the respective estimated arrival times, that is less than the estimated arrival time of the vehicle, is selected as the leader vehicle when a distance of the vehicle to the merge starting point is less than a threshold value. In some embodiments, the leader determination module is stored in a cloud unit adapted to interface with the controller. The leader determination module may be updateable via remote updates. In other embodiments, the leader determination module is stored in the vehicle.

The system may include one or more sensors adapted to detect and transmit respective data to the controller. The sensors may include vehicle sensors located in or around the vehicle, including at least one of a radar unit, a camera unit, a sonic unit and a LIDAR unit. The sensors may include an external sensor located outside the vehicle. The respective data may include vehicle parameters, road structure parameters and neighboring vehicle parameters. The vehicle parameters include global position coordinates, lane position, direction and speed of the vehicle. The road structure parameters may include an orientation of the first lane relative to the second lane and a geometry of the merging trajectory location. The neighboring vehicle parameters include respective global position coordinates, respective lane positions, respective direction and respective speed of the one or more neighboring vehicles.

In one embodiment, the estimated arrival time of the vehicle is based on the distance of the vehicle to the merge starting point and a representative velocity. The respective estimated arrival times may be based on a respective distance of the one or more neighboring vehicles to the merge starting point and the representative velocity. The representative velocity is a speed limit of at least one of the first lane and the second lane.

In another embodiment, the estimated arrival time of the vehicle is based on the distance of the vehicle to the merge starting point and a velocity of the vehicle. The respective estimated arrival times may be based on a respective distance of the one or more neighboring vehicles to the merge starting point and a respective velocity of the one or more neighboring vehicles.

In yet another embodiment, the estimated arrival time of the vehicle is based on the distance of the vehicle to the merge starting point and an average velocity of traffic ahead of the vehicle. The respective estimated arrival times may be based on a respective distance of the one or more neighboring vehicles to the merge starting point and the average velocity of the traffic ahead of the one or more neighboring vehicles.

Disclosed herein is method of operating an assistance system for a vehicle capable of automated operation, the vehicle having a controller with a processor and tangible, non-transitory memory. The method includes receiving respective data from one or more sensors, via the controller, wherein the vehicle is approaching a merging trajectory location defined by a merge starting point. When a distance of the vehicle to the merge starting point is less than a threshold value, the method includes: determining an estimated arrival time of the vehicle to the merge starting point based in part on the respective data, and determining respective estimated arrival times for the one or more neighboring vehicles to the merge starting point, via the controller. A leader vehicle is selected from the one or more neighboring vehicles based in part on the respective estimated arrival times, via the controller. Operation of the vehicle is controlled based in part on the leader vehicle, via the controller.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of an assistance system with a leader determination module for a vehicle;

FIG. 2 is a schematic fragmentary diagram illustrating an external sensor employable by the leader determination module of FIG. 1; and

FIG. 3 is a flowchart for a method of operating the leader determination module of FIG. 1.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

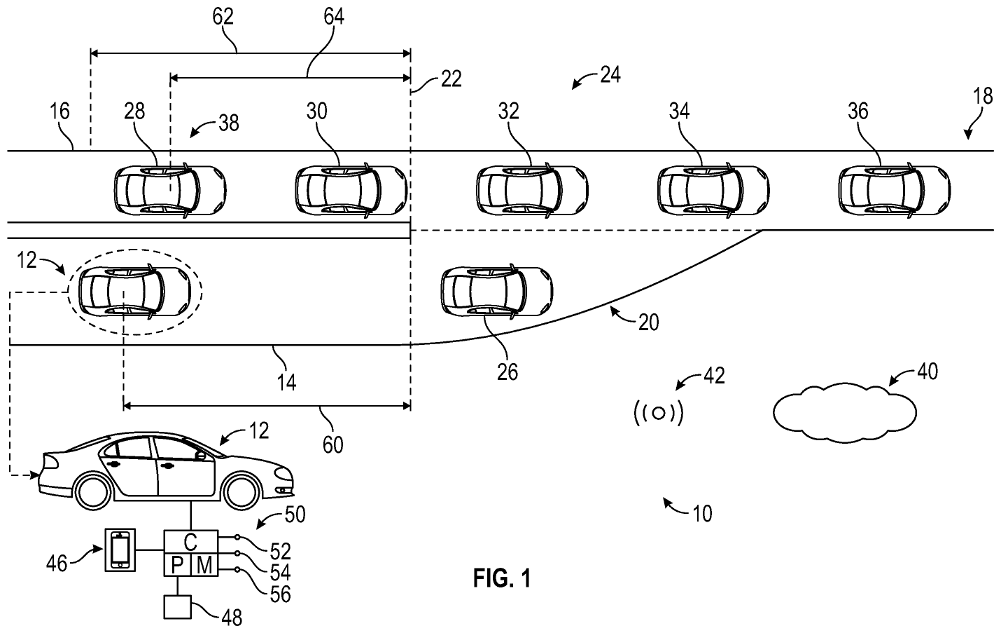

Referring to the drawings, wherein like reference numbers refer to like components, FIG. 1 schematically illustrates an assistance system 10 for a vehicle 12. The vehicle 12 may include, but is not limited to, a passenger vehicle, sport utility vehicle, light truck, heavy duty vehicle, minivan, bus, transit vehicle, bicycle, moving robot, farm implement (e.g., tractor), sports-related equipment (e.g., golf cart), boat, airplane and train. The vehicle 12 may be an electric vehicle, which may be purely electric or hybrid/partially electric. It is to be understood that the vehicle 12 may take many different forms and have additional components.

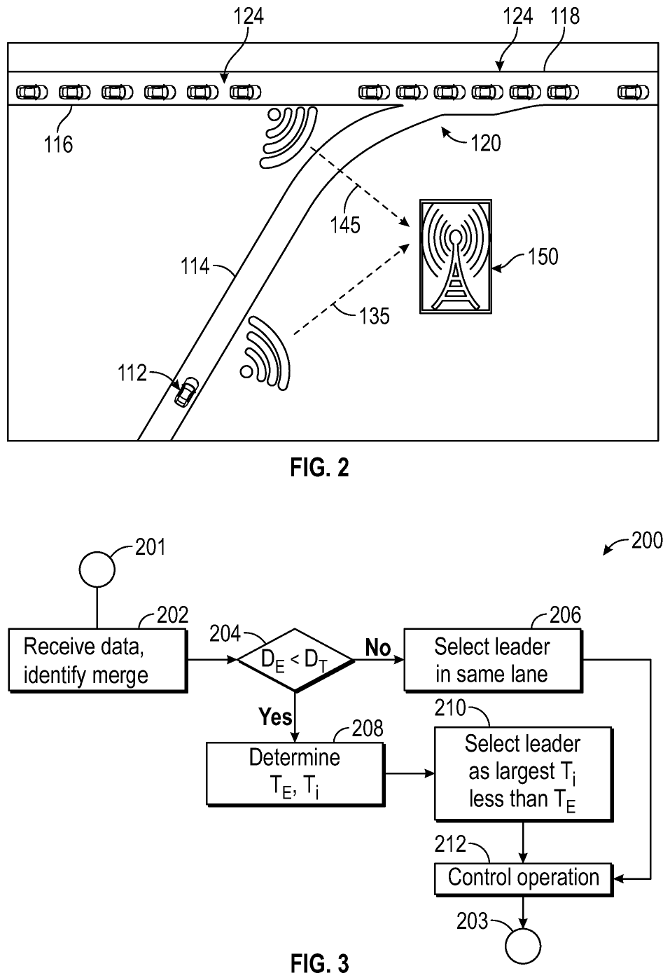

Referring to FIG. 1, the vehicle 12 is positioned in a first lane 14 which is in the vicinity of a second lane 16. The first lane 14 and the second lane 16 merge into a single road 18 at a merging trajectory location 20. The merging trajectory location 20 is defined by or characterized by a beginning, referred to herein as merge starting point 22. The merging trajectory location 20 may occur where two lanes physically merge into one lane or in an unstructured traffic scenario. The merge starting point 22 may be selected based on the application at hand. In other words, the merge starting point 22 may be selected from any part of the transition region between the area that has the first lane 14 and the second lane 16, to the area that has the single road 18. In the case of a merge in unstructured traffic, predictions of behavior (e.g., as an output of a different algorithm) may be employed to select the merge starting point 22. Referring to FIG. 1, the vehicle 12 is in the vicinity of one or more neighboring vehicles 24. The neighboring vehicles 24 may be in the same lane as the vehicle 12 or in an adjacent or nearby lane, such as car 26 in the first lane 14 and cars 28, 30, 32, 34, 36 in the second lane 16, as shown in FIG. 1. The neighboring vehicles 24 may be located at a relatively far distance (as described below with respect to FIG. 2).

Referring to FIG. 1, the vehicle 12 includes a controller C having at least one processor P and at least one memory M (or non-transitory, tangible computer readable storage medium) on which instructions are recorded for executing a leader determination module 200 (described below with respect to FIG. 3) for selecting a leader vehicle. By way of example, a leader vehicle 38 is selected from among the neighboring vehicles 24 of FIG. 1. Selection of the leader vehicle may have a significant impact on the driving behavior of the automated vehicle 12 and traffic flow. In the case of merging driving trajectories, such as in on-ramps and lane-merges, the selection of a leader vehicle is challenging. The module 200 determines a future leader in both urban and highway scenarios with merging trajectories, such as the merging junction 20.

The leader determination module 200 (hereinafter referred to as “module 200”) may be stored in the vehicle 12. In some embodiments, the module 200 may be stored in a remotely located or “off-board” cloud computing service, referred to herein as cloud unit 40, that interfaces with the controller C. The cloud unit 40 may include one or more servers hosted on the Internet to store, manage, and process data, maintained by an organization, such as for example, a research institute or a company. The leader determination module 200 may be updateable via remote updates.

Referring to FIG. 1, the controller C may be configured to communicate with the cloud unit 40 via a wireless network 42. The wireless network 42 of FIG. 1 may be a short-range network or a long-range network. The wireless network 42 may be a communication BUS, which may be in the form of a serial Controller Area Network (CAN-BUS). The wireless network 42 may incorporate a Bluetooth™ connection, a Wireless Local Area Network (LAN) which links multiple devices using a wireless distribution method, a Wireless Metropolitan Area Network (MAN) which connects several wireless LANs or a Wireless Wide Area Network (WAN). Other types of connections may be employed.

In some embodiments, the module 200 may be stored in a mobile application 46 that is in communication with the controller C. For example, the mobile application 46 may be physically connected (e.g., wired) to the controller C as part of the vehicle infotainment unit. The mobile application 46 may be embedded in a smart phone belonging to a user of the vehicle 12 and plugged or otherwise linked to the vehicle 12. The circuitry and components of a mobile application 46 (“apps”) available to those skilled in the art may be employed.

Referring to FIG. 1, the vehicle 12 may include a communication interface 48 enabling vehicle-to-vehicle (V2V) communication and/or a vehicle-to-everything (V2X) communication, such as Vehicle-to-Infrastructure (V2I), Vehicle-to-Pedestrian (V2P), Vehicle-to-Device (V2D) and Vehicle-to-Grid (V2G). The controller C of FIG. 1 may be an integral portion of, or a separate module operatively connected to, other controllers of the vehicle 12. For example, the controller C may be an electronic control unit (ECU) of the vehicle 12. The memory M can store controller-executable instruction sets, and the processor P can execute the controller-executable instruction sets stored in the memory M.

The vehicle 12 includes multiple sensors for perceiving the surrounding environment. Referring to FIG. 1, the vehicle 12 includes one or more vehicle sensors 50 that are affixed in or around the vehicle 12, for detecting and transmitting respective data to the controller C. The vehicle sensors 50 may incorporate various types of technology available to those skilled in the art. The vehicle sensors 50 may include, but are not limited to, a radar unit 52, a camera unit 54 and a sonic or LIDAR unit 56. The vehicle sensors 50 may further include a navigation sensor and an inertial measurement unit (not shown). It is understood that the respective locations of the sensors on/in the vehicle 12 may be varied based on the application at hand.

Referring now to FIG. 2, an external sensor 150 employable by the leader determination module 200 is shown. The external sensor 150 is located external to the vehicle 112, e.g., a few kilometers away or a few meters away. For example, the external sensor 150 may be a satellite radar unit, a road-side camera unit or a drone. The external sensor 150 may be a road-side cell tower or another suitable entity. FIG. 2 illustrates a vehicle 112 in a first lane 114 in the vicinity of one or more neighboring vehicles 124. The first lane 114 merges with a second lane 116 into a single road 118 via a merging junction 120. Here, the vehicle 112 is at a relatively far distance from the neighboring vehicles 124. The external sensor 150 provides a technical advantage in cases of limited observability, where vehicles on merging roads may not see each other in advance and cannot coordinate in time which of them will become the respective leader. The limited observability may be due to bad weather, the terrain (e.g., hilly area, wide junction) or other factors. Referring to FIG. 2, the external sensor 150 receives message transmissions 135 from the vehicle 112 and message transmissions 145 from the neighboring vehicles 124. The external sensor 150 senses each of the neighboring vehicles 124, (which may be through cameras, lidars, radars, or through communication messages), and then transmits their respective locations to each vehicle that requests them. It is understood that the neighboring vehicles 124 may be in the same lane as the vehicle 112.

Referring now to FIG. 3, an example flowchart of the module 200 is shown. Module 200 may be embodied as computer-readable code or instructions stored on and partially executable by the controller C of FIG. 1. Module 200 may be executed in real-time, continuously, systematically, sporadically and/or at regular intervals, for example, each 10 milliseconds during normal and ongoing operation of the vehicle 12. Module 200 of FIG. 3 begins at block 201 and ends at block 203. Module 200 need not be applied in the specific order recited herein. Furthermore, it is to be understood that some blocks or steps may be eliminated.

Per block 202 of FIG. 3, the controller C is programmed to receive respective data (from the vehicle sensors 50 and/or external sensor 150). It is to be understood that the respective data may be processed through a sensor processing module that converts the incoming signals to objects with respective location and speed. Also, per block 202, the controller C may be programmed to identify the presence or approach of a merging trajectory location 20. The respective data include vehicle parameters, road structure parameters, neighboring vehicle parameters and other suitable data. The road structure parameters may include the presence of the merging trajectory location 20 ahead, identification of a merge starting point 22 and the nature of the terrain (e.g., whether it is hilly or uneven). As noted above, the merging trajectory location 20 may occur where two lanes physically merge into one lane or in an unstructured traffic scenario. In the case of unstructured traffic, predictions of behavior (e.g., as an output of a different algorithm) may be employed to select the merge starting point 22. The road structure parameters may include a geometry (e.g., angle) of the merging trajectory location 20 and an orientation of the first lane 14 relative to the second lane 16. The vehicle parameters may include the global position coordinates, lane position, direction and speed of the vehicle 12 (and vehicle 112), as well as the distance 60 to the merge starting point 22 of the vehicle 12. The neighboring vehicle parameters may include the respective global position coordinates, respective lane positions, respective direction and respective speed of the neighboring vehicles 24. The neighboring vehicle parameters may include the respective distance 64 of the neighboring vehicles 24 to the merge starting point 22. It is understood that the distances 60, 64 may be measured from the front or mid-point or other preselected points of the vehicle.

Proceeding to block 204 of FIG. 3, the controller C is programmed to ascertain whether a distance 60 (D_{E}) of the vehicle 12 to the merge starting point 22 is less than a threshold value 62 (D_{T}). The threshold value 62 may be varied based on the application at hand and may depend on the geography of the merging junction 20, e.g., altitude, speed limit in that area, whether the merging junction 20 is in an urban city landscape or rural landscape.

If the distance 60 is greater than or equal to the threshold value 62 (block 204=NO), the module 200 advances to block 206 where the controller C is programmed to select the leader vehicle 38 as the preceding vehicle (or vehicle just ahead) that is in the same lane as the vehicle 12. If the distance 60 is less than the threshold value 62 (block 204=YES), the module 200 advances to block 208. Per block 208 of FIG. 3, the controller C is programmed to determine: (1) the estimated arrival time (T_{E}) of the vehicle 12 to the merge starting point 22; and (2) the respective estimated arrival times (Tᵢ) of each of the neighboring vehicles 24 to the merge starting point 22. These values may be estimated in a number of ways.

In one embodiment, the estimated arrival time (T_{E}) of the vehicle 12 is obtained as a ratio of the distance 60 (D_{E}) of the vehicle 12 to the merge starting point 22 and a representative velocity (T_{E}=D_{E}/V*). The respective estimated arrival times (Tᵢ) are based on a respective distance 64 (Dᵢ) of each of the neighboring vehicles 24 (shown for car 28) to the merge starting point 22 and the representative velocity (Tᵢ=Dᵢ/V*). The representative velocity (V*) is some measure of a speed and may be selected based on the particular application. For example, the representative velocity may be the speed limit of the first lane 14 or the second lane 16 or an average speed limit of the first lane 14 and the second lane 16. In another example, the representative velocity is the speed of the vehicle 12 or an average speed of a selected set of the neighboring vehicles 24.

In another embodiment, the estimated arrival time (T_{E}) of the vehicle 12 is obtained as a ratio of the distance 60 (D_{E}) of the vehicle 12 to the merge starting point 22 and a velocity of the vehicle 12 (T_{E}=D_{E}/V_{E}). Here, the respective estimated arrival times (Tᵢ) are a ratio of the respective distance 64 (Dᵢ) of each of the neighboring vehicles 24 to the merge starting point 22 and the respective velocity of the neighboring vehicles 24 (Tᵢ=Dᵢ/Vᵢ).

In yet another embodiment, the estimated arrival time (T_{E}) of the vehicle 12 is obtained as ratio of the distance 60 (D_{E}) of the vehicle 12 to the merge starting point 22 and an average velocity of traffic ahead of the vehicle 12 (T_{E}=D_{E}/V_{AVG}). Here, the respective estimated arrival times (Tᵢ) are a ratio of the respective distance 64 (Dᵢ) of each of the neighboring vehicles 24 to the merge starting point 22 and an average velocity of traffic ahead of the neighboring vehicles 24 (Tᵢ=Dᵢ/V_{AVG}).

Advancing from block 208 to block 210 of FIG. 3, the controller C is programmed to select the leader vehicle 38 as follows: the neighboring vehicle 24 with the greatest value of the estimated arrival time (Tᵢ) that is less than the estimated arrival time (T_{E}) of the vehicle 12 is selected as the leader vehicle 38. In other words, the leader vehicle 38 has a maximum value of (Tᵢ) amongst the neighboring vehicles 24, (for which Tᵢ<T_{E}). Proceeding to block 212, operation of the vehicle 12 is controlled based on the actions of the leader vehicle 38. In one example, the real-time speed and real-time acceleration of the vehicle 12 are modulated based on the speed of the leader vehicle 38. In another example, the lane changing position of the vehicle 12 is modified based on the leader vehicle 38.

In summary, the assistance system 10 (via execution of the module 200) provides an advantage in automated vehicle planning, reduces congestion and improves traffic flow. The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file rechargeable energy storage system, an application database in a proprietary format, a relational database energy management system (RDBMS), etc. Each such data store may be included within a computing device employing a computer operating system such as one of those mentioned above and may be accessed via a network in one or more of a variety of manners. A file system may be accessible from a computer operating rechargeable energy storage system and may include files stored in various formats. An RDBMS may employ the Structured Query Language (SQL) in addition to a language for creating, storing, editing, and executing stored procedures, such as the PL/SQL language mentioned above.

The flowchart in FIG. 3 illustrates an architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based rechargeable energy storage systems that perform the specified functions or acts, or combinations of specific purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An assistance system for a vehicle capable of automated operation, comprising:
a controller having a processor and tangible, non-transitory memory on which instructions are recorded;
wherein the vehicle is located on a first lane in a vicinity of one or more neighboring vehicles, the vehicle approaching a merging trajectory location defined by a merge starting point;
wherein the controller is adapted to selectively execute a leader determination module when a distance of the vehicle to the merge starting point is less than a threshold value, including:
determining an estimated arrival time of the vehicle to reach the merge starting point;
determining respective estimated arrival times for the one or more neighboring vehicles to reach the merge starting point;
selecting a leader vehicle from the one or more neighboring vehicles based in part on the respective estimated arrival times; and
controlling operation of the vehicle based in part on the leader vehicle.

2. The assistance system of claim 1, wherein the one or more neighboring vehicles having a greatest value of the respective estimated arrival times that is less than the estimated arrival time of the vehicle is selected as the leader vehicle, when a distance of the vehicle to the merge starting point is less than a threshold value.

3. The assistance system of claim 1, wherein the leader determination module is stored in a cloud unit adapted to interface with the controller, the leader determination module being updateable via remote updates.

4. The assistance system of claim 1, wherein the leader determination module is stored in the vehicle.

5. The assistance system of claim 1, further comprising:
one or more sensors adapted to detect and transmit respective data to the controller, the respective data including vehicle parameters, road structure parameters and neighboring vehicle parameters.

6. The assistance system of claim 5, wherein the one or more sensors include vehicle sensors located in or around the vehicle, including at least one of a radar unit, a camera unit, a sonic unit and a LIDAR unit.

7. The assistance system of claim 5, wherein the one or more sensors include an external sensor located outside the vehicle.

8. The assistance system of claim 5, wherein the vehicle parameters include global position coordinates, lane position, direction and speed of the vehicle.

9. The assistance system of claim 5, wherein:
the first lane merges with a second lane at the merging trajectory location, and the road structure parameters include an orientation of the first lane relative to the second lane and a geometry of the merging trajectory location.

10. The assistance system of claim 5, wherein the neighboring vehicle parameters include respective global position coordinates, respective lane positions, respective direction and respective speed of the one or more neighboring vehicles.

11. The assistance system of claim 5, wherein:
the estimated arrival time of the vehicle is based on the distance of the vehicle to the merge starting point and a representative velocity; and
the respective estimated arrival times are based on a respective distance of the one or more neighboring vehicles to the merge starting point and the representative velocity.

12. The assistance system of claim 11, wherein the representative velocity is a speed limit of at least one of the first lane and the second lane.

13. The assistance system of claim 5, wherein:
the estimated arrival time of the vehicle is based on the distance of the vehicle to the merge starting point and a velocity of the vehicle; and
the respective estimated arrival times are based on a respective distance of the one or more neighboring vehicles to the merge starting point and a respective velocity of the one or more neighboring vehicles.

14. The assistance system of claim 5, wherein:
the estimated arrival time of the vehicle is based on the distance of the vehicle to the merge starting point and an average velocity of traffic ahead of the vehicle; and
the respective estimated arrival times are based on a respective distance of the one or more neighboring vehicles to the merge starting point and the average velocity of the traffic ahead of the one or more neighboring vehicles.

15. A method of operating an assistance system for a vehicle capable of automated operation, the vehicle having a controller with a processor and tangible, non-transitory memory, the method comprising:
receiving respective data from one or more sensors, via the controller, wherein the vehicle is approaching a merging trajectory location defined by a merge starting point;
when a distance of the vehicle to the merge starting point is less than a threshold value:
determining an estimated arrival time of the vehicle to the merge starting point based in part on the respective data, via the controller;
determining respective estimated arrival times for the one or more neighboring vehicles to the merge starting point, via the controller;
selecting a leader vehicle from the one or more neighboring vehicles based in part on the respective estimated arrival times, via the controller; and
controlling operation of the vehicle based in part on the leader vehicle, via the controller.

16. The method of claim 15, further comprising:
selecting the leader vehicle from the one or more neighboring vehicles having a greatest value of the respective estimated arrival times that is less than the estimated arrival time of the vehicle.

17. The method of claim 16, further comprising:
determining the estimated arrival time of the vehicle as a ratio of the distance of the vehicle to the merge starting point and a representative velocity; and
determining the respective estimated arrival times as the ratio of a respective distance of the one or more neighboring vehicles to the merge starting point and the representative velocity.

18. The method of claim 16, further comprising:
determining the estimated arrival time of the vehicle as a ratio of the distance of the vehicle to the merge starting point and a velocity of the vehicle; and
determining the respective estimated arrival times as the ratio of a respective distance of the one or more neighboring vehicles to the merge starting point and a respective velocity of the one or more neighboring vehicles.

19. The method of claim 16, further comprising:
determining the estimated arrival time of the vehicle as a ratio of the distance of the vehicle to the merge starting point and an average velocity of traffic ahead of the vehicle; and
determining the respective estimated arrival times as the ratio of a respective distance of the one or more neighboring vehicles to the merge starting point and an average velocity of traffic ahead of the one or more neighboring vehicles.

20. An assistance system for a vehicle capable of automated operation, comprising:
a controller having a processor and tangible, non-transitory memory on which instructions are recorded;
one or more sensors adapted to detect and transmit respective data to the controller, including vehicle parameters, road structure parameters and neighboring vehicle parameters;
wherein the vehicle is located on a first lane in a vicinity of one or more neighboring vehicles, the first lane merging with a second lane at a merging trajectory location defined by a merge starting point;
wherein the controller is adapted to selectively execute a leader determination module when a distance of the vehicle to the merge starting point is less than a threshold value, including:
determining an estimated arrival time of the vehicle to the merge starting point;
determining respective estimated arrival times for the one or more neighboring vehicles to the merge starting point;
selecting a leader vehicle from the one or more neighboring vehicles, the leader vehicle having a greatest value of the respective estimated arrival times that is less than the estimated arrival time of the vehicle; and
controlling operation of the vehicle based in part on the leader vehicle.
